(19) United States
(12) Patent Application Publication
(10) Pub. No.: US 2004/0107135 A1
(43) Pub. Date: Jun. 3, 2004

(54) Electronic coupon distribution and redemption system and method

(76) Inventors: Craig Deatherage, Mesa, AZ (US); Jennifer Deatherage, Mesa, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/308,624

(22) Filed: Dec. 3, 2002

(51) Int. Cl. G06F 17/60

(52) U.S. Cl. 705/14; 235/380

(57) ABSTRACT

A system and method for distributing and redeeming discount coupons electronically. The system includes a card, a card reader, and a coupon data server computer. The card has user identification data stored thereon, and the card reader is operable to read, and transmit, the stored user identification data. The coupon data server computer stores discount coupon data stored that has not been selected by a user of the card, and is in communication with the card reader. The coupon data server computer is operable to receive the user identification data transmitted by the card reader and, in response thereto, to transmit at least a portion of the stored discount coupon data.

### FIELD OF THE INVENTION

The present invention relates to electronic coupons and, more particularly, to a system and method for distributing and redeeming electronic coupons.

### BACKGROUND OF THE INVENTION

Discount coupons have a relatively long history, dating back to at least the late 19^{th} century. According to many accounts, the first discount coupon was issued in 1894 by Asa Chandler. Mr. Chandler, who was a druggist by trade, had recently purchased the secret formula for Coca-Cola® and was anxious to receive feedback from customers. So, he wrote up his own coupons, entitling the holder to a free glass of the beverage at his drugstore. Shortly thereafter, according to many of these same accounts, C. W. Post began issuing discount coupons for purchase of his new cereal, Grape Nuts®.

Since the somewhat small, but auspicious beginning of discount coupons, the issuance and use of discount coupons has grown significantly, and are pervasive in today's economy. Indeed, it may sometimes seem that one cannot pickup a newspaper, magazine, circular, or other type of periodical, or go to their mail box, without coming across one or more discount coupons. As an example, one report estimated that more than 2.6 billion discount coupons were distributed in 2001. This same report estimated that consumers redeemed 122 million coupons in 2001, which translated to $128 million in savings.

Discount coupons can provide benefits to manufacturers, businesses, and consumers alike. For manufacturers, discount coupons provide a source of advertising or incentive to entice consumers to purchase one or more goods produced by the manufacturer, in the hope that the consumer will purchase the coupon-related good again, or will purchase other goods produced by the manufacturer, and thereby perhaps instill some brand loyalty. Similarly, for businesses, discount coupons may provide a source of advertising or incentive to entice consumers to the business to purchase at least those goods to which the discount coupons apply. Generally, these businesses hope that the consumer will purchase other products, which may or may not have associated discount coupons, during the same visit, or on a repeat visit. For consumers, the benefits include reduced purchase prices for those goods having associated discount coupons.

As with many other products and processes, conventional discount coupons also have certain disadvantages. Such disadvantages may include time investment by consumers, the inability of coupon providers to efficiently target particular consumers, and coupon fraud by consumers and/or retailers.

For example, typically before a consumer uses a conventional discount coupon, the consumer may look through a collection of conventional discount coupons, such as in a newspaper insert, then select those to be used, and cut or otherwise separate the selected ones from the collection. In some instances, the coupons are a collection of numerous products, many of which may or may not be of interest to the particular consumer. Such a process is sometimes referred to as “coupon clipping,” and a consumer who spends their time cutting out the coupons is sometimes referred to as a “coupon clipper.” Once the discount coupons are clipped, the consumer may then carry the discount coupons with them to the grocery store, select their items for purchase, and, upon completing their shopping, present their clipped discount coupons to the attendant at the check out register. This process can be quite time consuming and can, in some instances, work as a disincentive to coupon clipping.

Coupon fraud schemes may take many forms. In one form, offenders purchase or steal the Free Standing Inserts (FSIs) that accompany many Sunday newspapers. The coupons are then clipped, sometimes artificially aged or worn, sorted by product, grouped by store account number, and sent to a coupon clearinghouse. The clearinghouse then generates and mails one or more checks payable to the particular stores, or store owners, associated with the store account numbers. Clearinghouses typically require stores to register with the clearinghouse, and the clearinghouses generally verify the store's existence. However, some store owners have been found to have been complicit with, or in charge of, such fraud schemes. In some cases, coupon fraud is committed on a smaller scale by individual consumers. For example, a consumer purchasing a large number of items during peak business hours may provide the checkout register attendant with numerous coupons, some of which may be for items not purchased by the consumer. Because it is during peak business hours, the attendant may not take the time to verify the legitimacy of every coupon presented.

Moreover, it has been shown that coupon fraud schemes may have been used to fund various terrorist organizations and actions. For example, according to at least one report, the proceeds from at least one coupon fraud scheme were used to at least partially fund the World Trade Center bombing. Some people also believe that coupon fraud may have even been used to partially fund the World Trade Center attacks of Sep. 11, 2001.

Hence, there is a need for a system and method of distributing and redeeming discount coupons that addresses one or more of the drawbacks noted above. Namely, a system and method that does not rely on manual coupon clipping, and/or does not rely on distribution via the mail or newspapers, and/or a system that significantly reduces the likelihood of coupon fraud by store owners, consumers, and terrorists and terrorist organizations.

### SUMMARY OF THE INVENTION

The present invention provides a system and method for distributing and redeeming discount coupons that, among other things, is relatively easy and convenient for both consumers and businesses, minimizes the inefficiencies associated with coupon distribution, and also reduces the likelihood of coupon fraud.

In one embodiment, and by way of example only, a coupon redemption system includes a card, a card reader, and a coupon data server computer. The card has at least user identification data stored thereon. The card reader is operable to read the user identification data from the card and transmit the user identification data. The coupon data server computer has at least discount coupon data stored thereon that has not been selected by a user of the card. The coupon data server computer is in communication with the card reader and is operable to receive the user identification data transmitted by the card reader and, in response thereto, to transmit at least a portion of the stored discount coupon data.

In another exemplary embodiment, a coupon selection and redemption system includes a card, a first card reader, a coupon data server computer, and an intermediate client-server computer. The card has at least user identification data stored thereon. The first card reader is operable to read the user identification data from the card and transmit the user identification data. The coupon data server computer includes at least user-specific discount coupon data stored thereon, and is operable to transmit the user-specific discount coupon data in response to a user-specific request. The user-specific discount coupon data is associated with the user identification data. The intermediate client-server computer is in communication with the first card reader and the coupon data server computer. The intermediate client-server computer is operable to transmit the user-specific request to, and receive the user-specific discount coupon data transmitted from, the coupon data server computer, to receive the user identification data transmitted from the first card reader, and to automatically transmit the user-specific discount coupon data received from the coupon data server in response to receiving the user identification data transmitted from the first card reader.

In yet another exemplary embodiment, a coupon selection and redemption system includes a card, a card reader, and a coupon data server computer. The card has at least user identification data stored thereon. The card reader is operable to read the user identification data from the card and transmit the user identification data. The coupon data server computer has at least user-specific discount coupon data stored thereon and is operable to receive the transmitted user identification data and, in response thereto, to transmit the user-specific discount coupon data. The user-specific discount coupon data associated with the user identification data.

In still another exemplary embodiment a method of redeeming coupons electronically includes storing user identification data on a card, and storing discount coupon data that has not been selected by a user of the card on a coupon data server computer. The user identification data is read from the card and is transmitted. At least a portion of the stored discount coupon data is transmitted from the coupon data server computer in response to the reading of the user identification data.

In yet still a further exemplary embodiment, a method of redeeming coupons electronically includes storing user identification data on a card, and storing user-specific discount coupon data on a coupon data server computer. The user-specific discount coupon data is associated with the user identification data. The user-specific discount coupon data is transmitted from the coupon data server computer to an intermediate computer in response to a request. The stored user-specific identification data is read from the card., and the user-specific discount coupon data is transmitted from the intermediate computer in response to the reading of the stored user-specific identification data.

Other independent features and advantages of the preferred coupon selection and redemption system and method will become apparent from the following detailed description, taken in conjunction with the accompanying drawings which illustrate, by way of example, the principles of the invention.

### BRIEF DESCRIPTION OF THE DRAWINGS

FIG. 1 is a block diagram of a system according to an exemplary embodiment of the present invention;

FIG. 2 is a flowchart depicting the process implemented by the system of FIG. 1 according to an exemplary embodiment of the present invention;

FIG. 3 is a block diagram of a system according to an exemplary alternate embodiment;

FIG. 4 is a flowchart depicting the process implemented by the system of FIG. 3 according to an exemplary alternate embodiment; and

FIG. 5 is a block diagram of a system according to yet another exemplary alternate embodiment.

### DETAILED DESCRIPTION OF A PREFERRED EMBODIMENT

Before proceeding with a detailed description, a preliminary matter of connotation will first be addressed. Specifically, while it is recognized that there is a technological distinction between the Internet and the World Wide Web, the terms are used seemingly interchangeably throughout this description. The use of these terms in this fashion is for descriptive convenience only. The skilled artisan will appreciate that each of the described embodiments encompass the technological context of both the Internet and World Wide Web.

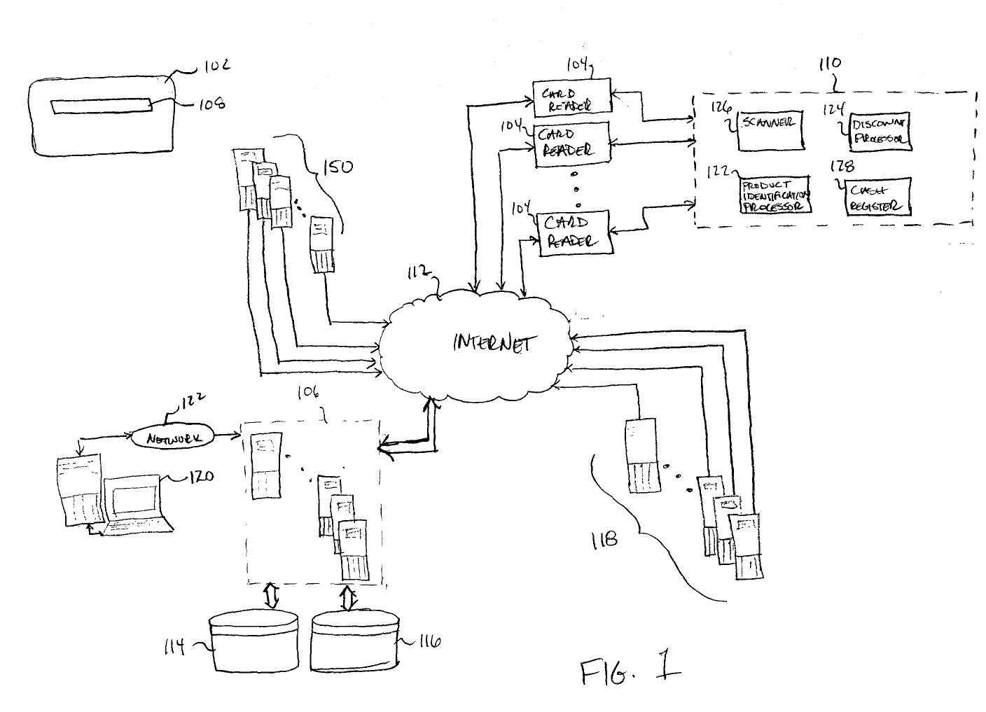

Turning now to the description, and with reference first to FIG. 1, a particular preferred coupon redemption system will be described. The system 100 includes one or more cards 102, one or more card readers 104, and one or more coupon data server computers 106. The cards 102 are preferably provided to individual users, though single or multiple cards could also be supplied to selected groups of people such as, for example, civic organizations, trade or other types of associations, church groups, and clubs. The cards 102 each store some type of user identification data 108. The user identification data 108 may include, but is not limited to, a unique number assigned by the issuer, a person's name, an address, a full or partial credit card number, a full or partial social security number, a unique number selected by the cardholder, or a combination of some or all of these in whole or in part. The cards 102 may be any one of numerous types of cards that are configured to store the user identification data 108, and that may allow the data 108 to be read at least by a machine, such as the card reader 104. For example, the cards 102 may have a readable bar code imprinted thereon, the cards 102 may include a magnetic strip similar to many credit cards, or the cards 102 may be smart cards that include one or more types of machine-readable memory.

The card readers 104 are preferably located at a point of sale location including, but not limited to, a grocery store, a convenience store, a restaurant, and other wholesale or retail sales locations. In a particular preferred embodiment, in which the point of sale location is a grocery store, one or more card readers 104 are located at each of the checkout isles or stands in the store. The card readers 104 are each in communication with the coupon data server computers 106 and with the store checkout system 110. The communication between the card readers 104 and the coupon data server computers 106, and between the card readers 104 and the checkout system 110 may be via hardwire, wireless, or via a distributed communications network such as, for example, the Internet 112. In a particular preferred embodiment, the card readers 104 are in communication with the checkout system 110 via a hardwire communication path, and with the coupon data server computers 106 via the Internet 112. It will be appreciated that, in another embodiment, the card readers 104 could form a part of the checkout system 110. For example, if the user identification data 108 is stored on the cards 102 in a UPC bar code format, and the checkout system includes a UPC bar code reader, then the UPC bar code reader could function as the card reader 104.

The card readers 104, as was alluded to above, are each configured to read the user identification data 108 stored on the cards 102, and to transmit the read user identification data 108 to at least the coupon data server computers 106. It will be appreciated that the user identification data 108 could also be transmitted to the store checkout system 110 for use by the store. It will additionally be appreciated that the programming used to implement this functionality is preferably stored in unillustrated memory within the card reader 104, and may be written using any one of numerous known programming languages including, but not limited to, Java, C, C++, and Perl.

The coupon data server computers 106 may be any one of numerous server computers known in the art. The operating system used to run the coupon data server computers 106 and the programming used in implementing the operations of the coupon data server computers 106 are stored in unillustrated memory. The operating system may be any one of numerous known operating systems including, but not limited to, Unix, Solaris, Linux, Free BSD, and any one of the Windows-based operating systems. Similarly, the implementing software may be written using any one of numerous known programming languages including, but not limited to, Java, C, C++, and Perl.

In the depicted embodiment, a plurality of databases are coupled to, or are integral with, the discount coupon data server computers 106. These databases include at a least discount coupon database 114 and a user database 116. The discount coupon database 114 stores at least discount coupon data, which are representative of the various types of conventional paper coupons that may be clipped and presented by a user to a store checkout clerk. As will be described more fully below, at least some of the discount coupon data is supplied to the checkout system 110 to credit the purchase price of certain products selected by a card user for purchase. The user database 116 stores user information data, which may include the same the user identification data 108 stored on the user's card 102, and/or some other type of data. The user information data is used, among other things, to verify that the card 102 being used at the store checkout isle is valid.

The discount coupon data may be stored onto the discount coupon database 114 in any one of numerous formats. The discount coupon data may also be placed onto the discount coupon database 114 in any one of numerous ways including, but not limited to, manual entry, or automatic entry via a magnetic or optical disk. In a particular preferred embodiment, however, the coupon data server computers 106 are in communication with one or more manufacturer and/or retailer server computers 118 via, for example, the Internet 112. Thus, discount coupon data from various manufacturers and/or retailers may be periodically and/or selectively downloaded from the manufacturer/retailer server computers 118 to the discount coupon database 114. It will be appreciated that this downloading action could occur automatically, as commanded by a user of one of the manufacturer/retailer server computers 118, or as commanded by a user of the coupon data server computers 106, or one or more separate computer terminals 120. The separate computer terminals 120 are preferably in communication with the coupon data server computers 106 via, for example, a local area network (LAN) 122. Although the term server computer is used throughout this description when referring to the coupon data server computers 106, it will be understood that the coupon data server computer 106 may also be considered a client computer when it is receiving data from an external source, such as the manufacturer/retailer computers 118, the computer terminals 120, or as will be described more fully below, the card readers 104 and/or the store checkout system 110. Nonetheless, for consistency, the term server computer will be used throughout.

The user information data may be stored onto the user database 116 in any one of numerous formats, and placed onto the user database 116 in any one or more of numerous ways. As with the discount coupon data, the user information data may be loaded manually, automatically via a removable storage medium, and/or via a communications network such as, for example, the Internet 112. For example, as will be described more fully below, user information may be provided on forms that have been filled out by hand, supplied from users or other remote locations on removable storage media, or transmitted to the computer terminals 120 or the coupon data server computers 106 via the Internet 112.

The checkout system 110, as shown in phantom in FIG. 1, is preferably configured to include at least a product identification processor 122 and a discount processor 124. The product identification processor 122 and the discount processor 124 may be integrally formed as part of the same unit, or be part of separate units. For example, the product identification processor 122 may be, or form part of, a UPC barcode scanner 126 that is installed in numerous store checkout isles. In addition, the discount processor 124 may be, or form part of, a cash register 128 that is also installed in numerous store checkout isles. It will be appreciated that the functions of the barcode scanner 126 and cash register 128, and thus the product identification processor 122 and the discount processor 124, could be integrated into a single unit. It will additionally be appreciated that the functions performed by the product identification processor 122 and the discount processor 124, which are described more fully below, could also be performed by an appropriately programmed single processor.

The product identification processor 122, as its name connotes, functions to identify products that a user has selected for purchase. Preferably, the product identification data uniquely identifies each of the different products that a user has selected for purchase. In addition to reading the product identification data, the product identification processor 122 preferably transmits the product identification data that it reads. In the depicted embodiment, the product identification data is transmitted to the card reader 104. It will be appreciated, however, that the product identification data could be transmitted directly to the coupon data server computers 106.

Depending upon the products selected, some or all of the product identification data that are read are transmitted to the card reader 104. For example, some (or all) of the products selected for purchase may not have associated discount coupon data, or the products may not be associated with the network that provides this type of electronic coupon redemption. In such exemplary circumstances, the card reader 104 may be configured to transmit only the product identification data for only some of the selected products. In other embodiments, the card reader 104 may be configured to transmit all of the product identification data, whether or not the product has associated discount coupon data or is associated with the network. In the latter instance, the coupon data server computers 106 will include, for example, a type of filtration algorithm that, based on the product identification data, will selectively retrieve for transmission discount coupon data from the discount coupon database 114 for only those products having associated discount coupon data.

The product identification data, in addition to being transmitted to the card reader 104, may also be used by the checkout system 110 to determine the sales price for each of the selected products. The checkout system 110 uses the sales price information data to keep a running sales total for the all the products selected for purchase. As will be described more fully below, after all of the products selected for purchase have been totaled, or during the totaling process, the discount processor 124 receives discount coupon data transmitted from one or more of the coupon data server computers 106, and credits the purchase price for those products having associated discount coupon data. The amount that is credited is preferably included in the transmitted discount coupon data, though the amount could be stored elsewhere and subsequently retrieved based on the discount coupon data.

As FIG. 1 additionally illustrates, the discount data server computers 106 may also be configured to communicate with one or more clearinghouse computers 150. Thus, the discount data server computers 106 may transmit applied discount coupon data to the clearinghouse computers 150. The applied discount coupon data represent purchase price credits applied by a store. The clearinghouse computers 150 will process these data so that the store will receive appropriate reimbursement for redeeming the electronic discount coupons.

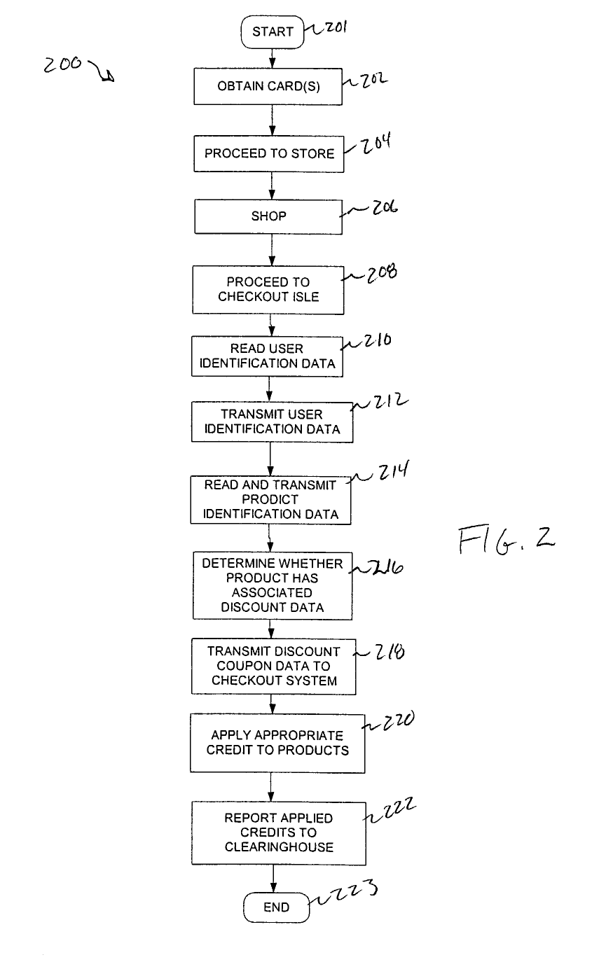

Having described the system hardware in detail, a detailed description of the methodology implemented by the system 100, and users thereof, to redeem electronic discount coupons according to a particular preferred embodiment will now be provided. In doing so, reference should be made to FIG. 2 in combination with FIG. 1. In the following discussion, the steps indicated in parentheses correspond with applicable flowchart steps in FIG. 2.

Initially, a user registers with the service provider and obtains one or more of the cards 102 (STEP 202). This may be done using any one of numerous processes. For example, the user may manually fill out an application form and send it to a prescribed address along with a prescribed payment (or authorization to charge a credit or other account). It will be appreciated that the application process could also be done via a computer terminal, which may be located in the user's home, or at a site that is remote from the user's home. For example, one or more computer terminals may be located in a store or other authorized location. The filled-out application form could be printed out from the user's computer terminal or one of the remote computer terminals, and mailed to the prescribed address along with the prescribed payment, or it could be transmitted, via the Internet 112, to another computer. This other computer may be one of the coupon data server computers 106 or, preferably, one of the computer terminals 120. In any case, once the user's application has been properly processed, the user database 116 is updated with information about the user. The number of requested cards 102 may then be sent to the user with the above-described user identification data 108 stored on each. In some instances, the card (or cards) 102 may be given to the user almost immediately, or in a short time period, after the application is filled-out. For example, the application data may be supplied and transmitted to one of the computer terminals 120 from a store or other authorized location. In such a case, the user database 116 may be updated relatively quickly (e.g., in substantially real-time), and a card 102 with the user identification data 108 may be provided to the user at the store or other authorized location.

Upon receipt of the cards 102, the user may then proceed to a store that utilizes the system 100 (STEP 204). When the user is in the store, the user may shop as they normally would (STEP 206). In a preferred embodiment, some sort of signifying indicia is provided for those products that have discount coupon data stored on the discount coupon database 114. Such signifying indicia may take many forms, including either, or both, visual and audio. No matter the form, however, the indicia will preferably alert the user that the product has associated discount coupon data stored on the discount coupon database 114.

Once the user has completed their shopping, they may then proceed to the checkout isle (STEP 208). In the preferred embodiment, the user's card 102 is first read by one of the card readers 104 located at the checkout isle (STEP 210). Once the card 102 is read, the card reader 104 transmits the user identification data 108 read from the card 102 to one or more of the coupon data server computers 106 (STEP 212). Thereafter, or substantially simultaneous therewith, the items the user selected for purchase are processed by checkout system 110. As part of this processing, as was noted above, the product identification data for each of the products selected for purchase is read by the checkout system 110 and is transmitted to one or more of the coupon data server computers 106 (STEP 214).

The coupon data server computers 106 process the received product identification data to determine whether the product has associated discount coupon data stored in the discount coupon database 114 (STEP 216). After all of the products have been processed, the coupon data server computers 106 transmit discount coupon data for each product having associated discount coupon data to the checkout system 110 (STEP 218). In the depicted embodiment, the discount coupon data is transmitted to the checkout system 110 via the card reader 104. It will be appreciated, however, that the discount coupon data could be transmitted directly to the checkout system 110. In any case, the checkout system 110, upon receipt of the discount coupon data, applies the appropriate amount of credit to the price of each appropriate product (STEP 220). To ensure the store obtains appropriate reimbursement, the discount server computers 106 report the applied credits to the clearinghouse computers 150 (STEP 222). Alternatively, the applied discounts may be reported to the store's accounting system.

It will be appreciated that the process described above and depicted in FIG. 2 is only exemplary of a particular preferred embodiment, and that certain parts of the process could vary. For example, the system software could be configured to allow the user's card 102 to be read by the card reader 104 after, or while, the products selected for purchase are being processed by the checkout system 110. In such an instance, the product identification data read by the checkout system 110 could, for example, be transmitted to the coupon data server computers 106 after all of the selected products have been identified.

With the above-described embodiments, coupons can be redeemed by card users without the users having to clip any of the coupons, either manually or electronically. In other words, any electronic discount coupons, represented by the discount coupon data stored on the discount coupon database, that are associated with any of the products a card user selects for purchase are automatically applied, without the user having to select the particular coupons prior to purchasing the selected products. In alternative embodiments, the system is configured such that card users do select particular electronic coupons prior to purchasing selected products. These alternative embodiments will now be described.

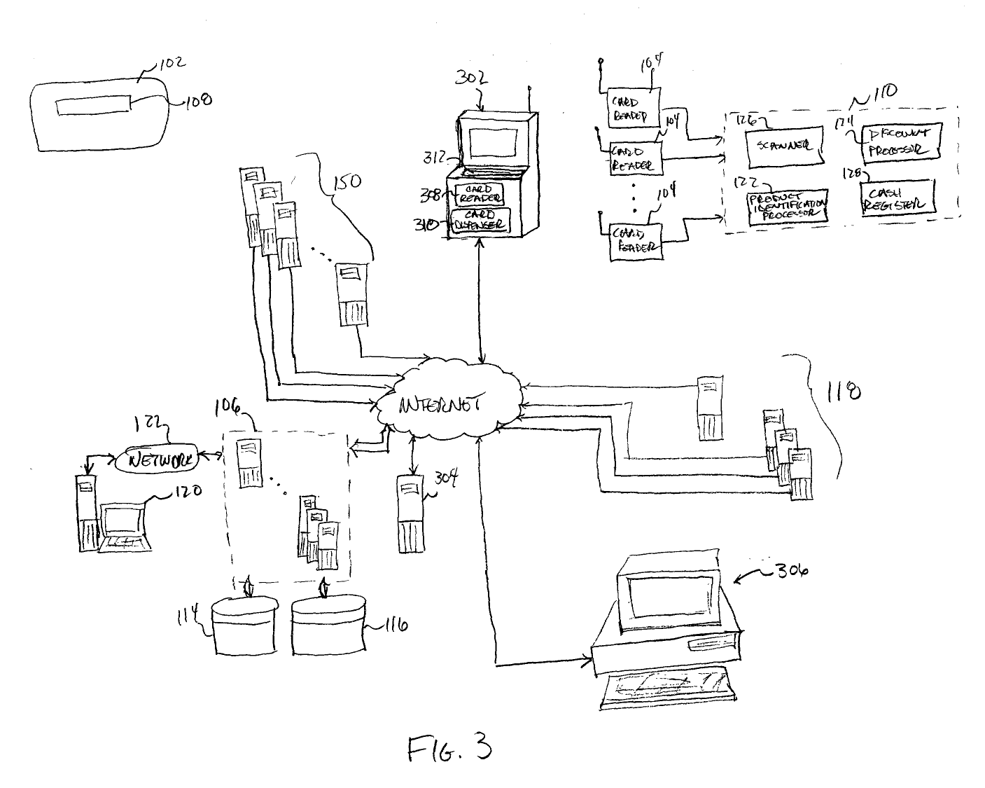

One particular alternative embodiment is depicted in FIG. 3, and includes some of the same components and features of the previously described embodiments. As such, like components in FIGS. 1 and 3 are referenced using like numerals. In addition to the components shown in FIG. 1, the system 300 depicted in FIG. 3 includes one or more intermediate client-server computers 302. Moreover, as will be discussed in more detail below, with this alternative embodiment, a card user may use a client computer to access one or more webpages via a distributed communications network such as, for example, the Internet 112, and select desired coupons for redemption.

Thus, as FIG. 3 illustrates, the system 300 includes one or more of the cards 102, one or more of the card readers 104, and one or more of the coupon data server computers 106. The cards 102 are substantially identical to that of the first embodiment, and will therefore not be further discussed. The card readers 104 are also configured, and operate, substantially identical to those described in the previous embodiment, except that each is in communication with one or more of the intermediate client-server computers 302. The purpose for this communication capability, and any configuration differences in the card readers 104 that implement this capability, will be discussed further below.

The coupon data server computers 106, the user identification database 114, and the discount coupon database 116 are also configured, and operate, substantially identical to those described in the previous embodiment. However, the coupon data server computers 106 are also in communication with the intermediate client-server computers 302 via, for example, the Internet 112. The coupon data server computers 106 may also have the above-mentioned webpage(s) resident in unillustrated memory. Alternatively, the webpage(s) may be resident on one or more separate, dedicated server computers 304 that provide users access to the webpage(s) via a dedicated website or web portal.

No matter where the webpage(s) is (are) located, a user may access the website or web portal, and view the webpage(s), using a client computer 306. The client computer 306 may be any one of numerous types of devices capable of accessing the coupon data server computers 106 or the dedicated server computers 304 via the Internet 112, and capable of displaying the stored webpage(s) using any one of numerous web browser software packages. Such devices include, but are not limited to, personal computers (PCs) (both IBM-compatible and MacIntosh), hand held computing devices (e.g., “PDAs”), cellular telephones, and web-based television sets. The content of the webpage(s) allow a user to view, via the client computer 306, various different manufacturer and/or retailer coupons. The website also enables a user to select one or more of the displayed coupons via, for example, an electronic shopping cart paradigm, for storage in the discount coupon database 116. The format in which the coupons are displayed on the website may be any one of numerous forms. Preferably, however, the coupons are not displayed and/or rendered to include certain indicia such as, for example, bar codes that are printed on numerous conventional coupons, to prohibit unauthorized printing and reproduction of the displayed coupons.

One or more of the intermediate client-server computers 302 are located in or near a store. As FIG. 3 depicts, the intermediate client-sever computers 302 preferably take the form of a stand alone kiosk. It will be appreciated, however, that this is merely exemplary of a preferred embodiment, and that the intermediate client-server computers 302 could take various other forms such as, for example, one or more PCs or ATMs (“automatic teller machines”).

No matter the particular physical form, each of the intermediate client-server computers 302 is configured to communicate with each of the card readers 104 that are located in the same store, and with the coupon data server computers 106. In the preferred embodiment, the intermediate client-server computers 302 communicate with the card readers 104 via wireless communication technology such as, for example, via RF (“radio frequency”) communication. As such, in the preferred embodiment, each client-server computer 302 includes the equipment and circuitry to implement wireless RF communications. For example, each client-server computer 302 may include an antenna, appropriate RF modulation/demodulation circuitry, analog-to-digital (A/D) conversion circuitry, digital-to-analog (D/A) conversion circuitry, and any appropriate interface circuitry. Similarly, the card readers 104 will also each include the equipment and circuitry to implement wireless RF communications. It should be appreciated that the particular type of wireless communication between the card readers 104 and the intermediate client-server computers 302 is not limited to RF, but is merely exemplary of a particular preferred embodiment. It will be appreciated that one or more of these circuits could be implemented in hardware, software, or a combination of both.

As was noted above, the intermediate client-server computers 302 are also in communication with the coupon data server computers 106. As was also noted above, this communication is preferably via a distributed communications network such as, for example, the Internet 112. Thus, each client-server computer 302 also preferably includes at least one or more processors, memory, operating system software, programming software, browser software, and an Internet communications interface such as, for example, a dedicated link (e.g., a T-1 link, or other similar technology), a digital subscriber link (DSL), a dial-up modem connection, or any other method known in the art, both now and in the future.

In addition to being configured to communicate with the card readers 104 and coupon data server computers 106, the intermediate client-server computers 302 are also preferably configured to read the cards 102, and may also be configured to dispense cards 102. Thus, the client-server computers 302 are also equipped with one or more card readers 308, and may also be equipped with a card dispenser 310. A user interface 312 such as, for example, a keyboard, a touch screen, or speech synthesizer, allows users to enter data, as queried by the client-server computer 302.

The operating system used to run the intermediate client-server computers 302 and the programming used in implementing the operations of the client-server computers 302 are stored in memory. Similar to the coupon data server computers 106, the operating system may be any one of numerous known operating systems including, but not limited to, Unix, Solaris, Linux, Free BSD, and any one of the Windows-based operating systems. Similarly, the implementing software may be written using any one of numerous known programming languages including, but not limited to, Java, C, C++, and Perl.

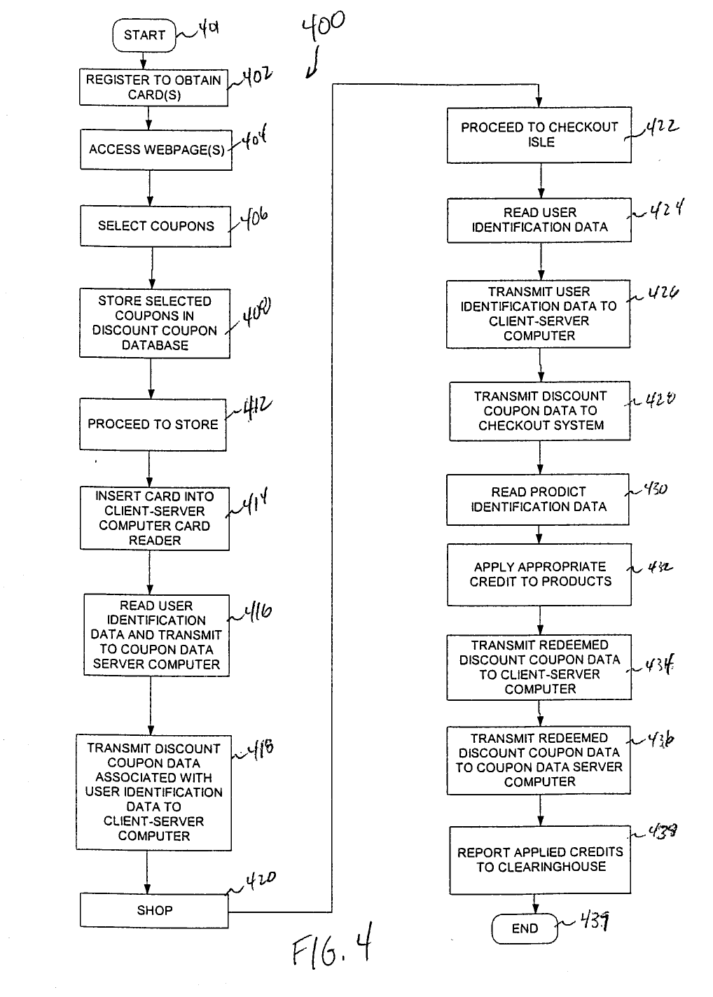

The remainder of the components that make up the alternative system 300 are substantially identical in structure and function to those of the previously described embodiments and will, therefore, not be further described in detail. Rather, a detailed description of a particular preferred methodology implemented by the system 300, and users thereof, to select and redeem electronic discount coupons will now be described. In doing so, reference should be made to FIG. 4, in combination with FIG. 3. As before, the steps indicated in parentheses correspond with applicable flowchart steps in FIG. 4.

Similar to the previously described method, a user first registers with the service provider and obtains one or more of the cards 102 (STEP 402). Any one of the previously described exemplary processes for obtaining the cards 102 may be used. In addition, as was alluded to above, a user may obtain one or more cards from one of the intermediate client-server computers 302. To do so, a user first enters the appropriate application data via, for example, the user interface 310, and transmits the data to another computer such as, for example, one of the computer terminals 120 or directly to one of the coupon data server computers 106. In either case, the user database 116 is updated and a card 102 with appropriate user identification data 108 stored thereon is dispensed by the intermediate client-server computer 302, via the card dispenser 310.

Once a user has successfully registered with the service provider, the user may then access the website or webportal via the client computer 306, to thereby access and view the webpage(s) that contain images and/or data representative of discount coupons (STEP 404). It will be appreciated that this may occur either before or after the user has received the one or more cards 102 they have requested. The user may access the website by any one of numerous known methods such as, for example, typing in the URL (Uniform Resource Locator) of the website directly into the client computer browser, by selecting a hyperlink that may be displayed on another website or as part of an e-mail transmitted to the user, or selecting the URL from a list of previously stored URLs.

Upon accessing the website, the user then navigates, if necessary, to the webpage(s), to thereby view various different manufacturer and/or retailer coupons on the client computer browser. It will be appreciated that the user may not need to navigate to a separate webpage to view the coupons. Instead, the coupon viewing and selection webpage could be the initial webpage displayed by the website upon access. In either case, once at the viewing and selection webpage, the user may then select the number and types of coupons displayed thereon (STEP 406). The method by which users select the type and number of coupons may vary. In a preferred embodiment, however, the selection scheme is via the well-known electronic shopping cart paradigm. No matter the particular method, the type and number of coupons selected by the user are stored as discount coupon data in the discount coupon database 114 (STEP 408). In the preferred embodiment, the user's discount coupon data is associated, or otherwise indexed, to the user identification data 108 that is (or will be) stored on the user's card(s) 102. While not depicted, the user may, in some embodiments, also print a list of the coupons they have selected for storage in the discount coupon database. This list may be printed to, for example, memory, a printer, or a print queue. In any case, once the user has received their card(s) 102, the user may then proceed to a store that utilizes the system 300 (STEP 412).

Preferably, when the user is at the store, the user first proceeds to the local intermediate client-server computer 302 and inserts their card 102 into the client-server computer card reader 308 (STEP 414). Upon insertion of the card 102 into the client-server card reader 308, the card reader 306 reads the user identification data 108 stored on the card 102 and transmits this data to the coupon data server computers 106 (STEP 416). The coupon data server computers 106 receive the user identification data 108 transmitted from the intermediate client-server computer 302, and transmit the discount coupon data associated with the received user identification data 108 to the intermediate client-server computer (STEP 418). If the user has not previously printed out a list of the type and number of selected coupons, or has not brought the list with them, or just wants another list, the user may print the list, if a local printer is provided. It will be appreciated that the local printer may form a part of the local intermediate client-server computer 302. The user may then proceed with their normal shopping (STEP 420).

Once the user has completed their shopping, they may then proceed to the checkout isle (STEP 422). In the preferred embodiment, the user's card 102 is first read by one of the card readers 104 located at the checkout isle (STEP 424). The card reader 104 reads the user identification data 108 on the card 102 and transmits the read user identification data 108 to the intermediate client-server computer 302 (STEP 426). Upon receiving the user identification data 108, the intermediate client-server computer 302 transmits the discount coupon data associated with the received user identification data 108 to the checkout system 110, preferably via the same card reader 104 that read the user's card 102 (STEP 428). As with the previous embodiments, it will be appreciated that the card readers 104 could form an integral part of the checkout system 110.

After the card 102 is read, or substantially simultaneous therewith, the items the user selected for purchase are processed by the checkout system 110. As part of this processing, the product identification data for each of the products selected for purchase is read by the checkout system 110 (STEP 430). Each time a product identified by the checkout system 110 has associated discount coupon data (e.g., an electronic coupon) that was transmitted from the intermediate client-server computer 302, the appropriate amount of credit is applied to the price of the product (e.g., the electronic coupon is redeemed) (STEP 432).

The card reader 104 relays information regarding the electronic coupons that were redeemed (e.g., redeemed discount coupon data) back to the intermediate client-server computer 302 (STEP 434). It will be appreciated that this may be done each time an electronic coupon is redeemed, or after all of the products have been processed. The intermediate client-server computer 302 then sends the redeemed discount coupon data back to the coupon data server computer 106 (STEP 436). If the card reader 104 transmits redeemed discount coupon data each time an electronic coupon is redeemed, the intermediate client-server computer 106 can similarly transmit the redeemed discount coupon data back to the coupon data server computer 106, or wait until all of the redeemed discount coupon data associated with the current user is received. No matter the case, to ensure the store obtains appropriate reimbursement, the discount server computers 106 report the applied credits to the clearinghouse computers 150 (STEP 438). Alternatively, the applied discounts may be reported to the store's accounting system.

It will be appreciated that the process described above and depicted in FIG. 4 is only exemplary of a particular preferred embodiment, and that certain parts of the process could vary. For example, the system software could be configured to allow the user's card 102 to be read by the card reader 104 after, or while, the products selected for purchase are being processed by the checkout system 110. In such an instance, the credits would preferably be applied to the product prices after all of the selected products have been identified.

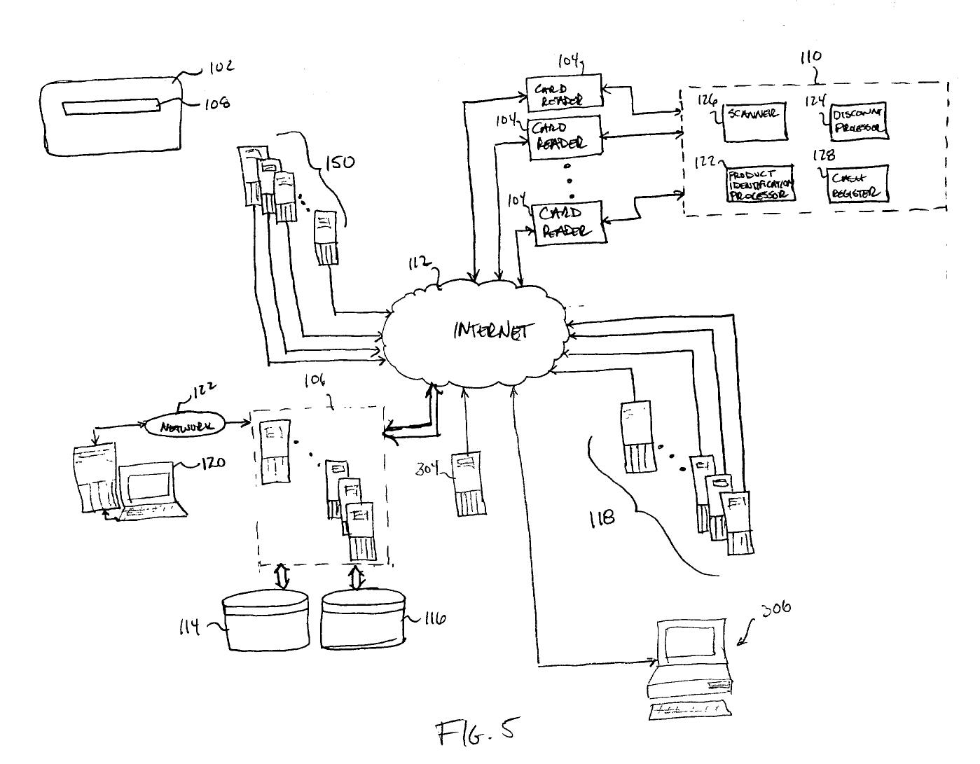

Yet another alternative system 500 is illustrated in FIG. 5. This alternative system operates substantially similar to that described above and illustrated in FIG. 3, except that the intermediate client-server computer(s) 302 are not included. Instead, as with the system 100 illustrated in FIG. 1, the card readers 104 communicate directly with the coupon data server computer(s) 106. The process implemented using the alternative system 500 of FIG. 5 is substantially similar to that described above and illustrated in FIG. 4, except that the user does not have their card 102 read by the intermediate client-server computer card reader 308 and, as was just noted, the coupon data server computer(s) 106 communicate directly with the card readers 104, rather than via the intermediate client server computer 302. The operation and interconnection of this alternate system 500 is readily apparent and will, therefore, not be described in any further detail.

The discount coupon distribution and redemption system and method described herein is relatively easy and convenient for both consumers and businesses. In addition, the system and method minimizes the inefficiencies associated with coupon distribution and selection, and also reduces the likelihood of coupon fraud.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A coupon redemption system, comprising:
a card having at least user identification data stored thereon;
a card reader operable to read the user identification data from the card and transmit the user identification data; and
a coupon data server computer having at least discount coupon data stored thereon that has not been selected by a user of the card, the coupon data server computer in communication with the card reader and operable (i) to receive the user identification data transmitted by the card reader and, in response thereto, (ii) to transmit at least a portion of the stored discount coupon data.

2. The system of claim 1, wherein the card reader is further operable to receive the discount coupon data transmitted by the coupon data server.

3. The system of claim 2, wherein the card reader is further operable to transmit the discount coupon data received from the coupon data server computer.

4. The system of claim 3, further comprising:
a checkout system operable to receive the discount coupon data from the card reader.

5. The system of claim 4, wherein the checkout system comprises:
a discount processor operable (i) to receive the discount coupon data from the card reader and, in response thereto, (ii) to supply purchase discount data.

6. The system of claim 4, wherein the checkout system comprises:
a product identification processor in communication with the card reader and operable to transmit product identification data representative of one or more products selected for purchase to the card reader.

7. The system of claim 6, wherein the card reader is further operable to transmit the received product identification data for at least those products selected for purchase that are eligible to receive discounts based at least in part on the stored discount coupon data.

8. The system of claim 6, wherein the product identification processor is further operable to read product identification indicia on the products selected for purchase and generate the product identification data therefrom.

9. The system of claim 1, further comprising:
a checkout system operable to receive the discount coupon data transmitted by the coupon data server computer.

10. The system of claim 9, wherein the checkout system comprises:
a discount processor operable (i) to receive the discount coupon data from the coupon data server computer and, in response thereto, (ii) to supply purchase discount data.

11. The system of claim 9, wherein the checkout system comprises:
a product identification processor in communication with the card reader and operable to transmit product identification data representative of one or more products selected for purchase to the card reader.

12. The system of claim 11, wherein the card reader is further operable to transmit the received product identification data for at least those products selected for purchase that are eligible to receive discounts based at least in part on the stored discount coupon data.

13. The system of claim 11, wherein the product identification processor is further operable to read product identification indicia on the products selected for purchase and generate the product identification data therefrom.

14. The system of claim 1, wherein:
the card reader is coupled to a communications network; and
the user identification data is transmitted at least over the communications network.

15. The system of claim 1, wherein the card reader transmits the user identification data via radio frequency transmission.

16. The system of claim 1, wherein:
the coupon data server computer is coupled to a communications network; and
the discount coupon data is transmitted at least over the communications network.

17. The system of claim 1, wherein the user identification data is stored on one or more magnetic strips coupled to the card.

18. The system of claim 1, wherein the card is a smart card having a memory for storing at least the user identification data therein.

19. The system of claim 1, wherein the user identification data is stored on the card as bar codes.

20. The system of claim 1, further comprising:
one or more clearinghouse computers coupled to receive at least a portion of the discount coupon data transmitted from the coupon data server computer,
wherein the discount coupon data received by the clearinghouse computers is used to determine reimbursement amounts.

21. The system of claim 1, wherein the coupon data server computer is at least periodically coupled to receive the discount coupon data from one or more manufacturer computers.

22. A coupon selection and redemption system, comprising:
a card having at least user identification data stored thereon;
a first card reader operable to read the user identification data from the card and transmit the user identification data;
a coupon data server computer including at least user-specific discount coupon data stored thereon and operable to transmit the user-specific discount coupon data in response to a user-specific request, the user-specific discount coupon data associated with the user identification data; and
an intermediate client-server computer in communication with the first card reader and the coupon data server computer, the intermediate client-server computer operable to:
(i) transmit the user-specific request to, and receive the user-specific discount coupon data transmitted from, the coupon data server computer, and
(ii) receive the user identification data transmitted from the first card reader, and automatically transmit the user-specific discount coupon data received from the coupon data server in response to receiving the user identification data transmitted from the first card reader.

23. The system of claim 22, wherein the first card reader is further operable to transmit redeemed user-specific discount coupon data, the redeemed user-specific discount coupon data representative of electronic coupons that have been redeemed by a user.

24. The system of claim 22, wherein the first card reader is further operable to receive the user-specific discount coupon data transmitted by the intermediate client-server computer.

25. The system of claim 24, wherein the first card reader is further operable to transmit the user-specific discount coupon data received from the intermediate client-server computer.

26. The system of claim 25, further comprising:
a checkout system operable to:
(i) receive at least a portion of the user-specific discount coupon data transmitted from the first card reader; and
(ii) transmit user-specific redeemed discount coupon data, the redeemed user-specific discount coupon data representative of electronic coupons that have been redeemed by a user.

27. The system of claim 26, wherein the checkout system comprises:
a discount processor operable (i) to receive at least a portion of the user-specific discount coupon data transmitted from the first card reader and, in response thereto, (ii) to supply purchase discount data and thereby generate the redeemed user-specific discount coupon data.

28. The system of claim 27, wherein the discount processor is further operable to transmit redeemed user-specific discount coupon data.

29. The system of claim 28, wherein the first card reader is further operable to receive the redeemed user-specific redeemed discount coupon data transmitted by the discount processor.

30. The system of claim 29, wherein:
the first card reader is further operable to transmit the user-specific redeemed discount coupon data; and
the intermediate client-server computer is further operable to receive the redeemed discount coupon data transmitted from the first card reader.

31. The system of claim 30, wherein the intermediate client-server computer is further operable to transmit the redeemed discount coupon data to the coupon data server computer.

32. The system of claim 24, wherein the checkout system comprises:
a product identification processor operable to read product identification indicia on the products selected for purchase and generate the product identification data therefrom.

33. The system of claim 22, further comprising:
a checkout system operable to:
(iii) receive at least a portion of the user-specific discount coupon data transmitted from the intermediate client-server computer; and
(iv) transmit user-specific redeemed discount coupon data, the redeemed user-specific discount coupon data representative of electronic coupons that have been redeemed by a user.

34. The system of claim 33, wherein the checkout system comprises:
a discount processor operable (i) to receive at least a portion of the user-specific discount coupon data from the intermediate client-server computer and, in response thereto, (ii) to supply purchase discount data and thereby generate the redeemed user-specific discount coupon data.

35. The system of claim 33, wherein the intermediate client-server computer is further operable to receive the redeemed discount coupon data transmitted by the checkout system.

36. The system of claim 35, wherein the intermediate client-server computer is further operable to transmit the redeemed discount coupon data to the coupon data server computer.

37. The system of claim 22, further comprising:
a second card reader in communication with the intermediate client-server computer and operable to read the user identification data from the card and transmit the user identification data to the intermediate client-server computer,
wherein the intermediate client-server computer, in response to receipt of the user identification data from second card reader, transmits the user-specific request to the coupon data server computer.

38. The system of claim 22, wherein:
the intermediate client-server computer includes a second card reader operable to read the user identification data from the card; and
the intermediate server computer is further operable to transmit the user-specific request to the coupon data server in response to the second card reader reading the user identification data from the card.

39. The system of claim 22, wherein:
the first card reader is coupled to a communications network; and
the user identification data is transmitted at least over the communications network.

40. The system of claim 22, wherein the first card reader transmits the user identification data via radio frequency transmission.

41. The system of claim 22, wherein:
the coupon data server computer is coupled to a communications network; and
the discount coupon data is transmitted at least over the communications network.

42. The system of claim 22, further comprising:
one or more web pages each having one or more electronic coupons formatted for display on, and selection from, a browser display screen of a client computer.

43. The system of claim 42, wherein the user-specific discount coupon data is stored on the coupon data server computer in response to a user selecting one or more of the electronic coupons displayed in the browser display screen.

44. The system of claim 42, wherein the one or more web pages are stored on the coupon data server computer.

45. The system of claim 42, wherein the one or more web pages are stored on one or more separate server computers.

46. The system of claim 22, wherein the intermediate client-server computer is a stand-alone kiosk.

47. The system of claim 22, wherein the user identification data is stored on one or more magnetic strips coupled to the card.

48. The system of claim 22, wherein the user identification data is stored on the card as bar codes.

49. The system of claim 22, wherein the card is a smart card having a memory for storing at least the user identification data therein.

50. A coupon selection and redemption system, comprising:
a card having at least user identification data stored thereon;
a card reader operable to read the user identification data from the card and transmit the user identification data;
a coupon data server computer including at least user-specific discount coupon data stored thereon and operable to (i) receive the transmitted user identification data and (ii), in response thereto, to transmit the user-specific discount coupon data, the user-specific discount coupon data associated with the user identification data.

51. The system of claim 50, wherein the card reader is further operable to transmit redeemed user-specific discount coupon data, the redeemed user-specific discount coupon data representative of electronic coupons that have been redeemed by a user.

52. The system of claim 50, wherein the card reader is further operable to receive the user-specific discount coupon data transmitted by the coupon data server computer.

53. The system of claim 52, wherein the card reader is further operable to transmit the user-specific discount coupon data received from the coupon data server computer.

54. The system of claim 53, further comprising:
a checkout system operable to:
(i) receive at least a portion of the user-specific discount coupon data transmitted from the card reader; and
(ii) transmit user-specific redeemed discount coupon data, the redeemed user-specific discount coupon data representative of electronic coupons that have been redeemed by a user.

55. The system of claim 54, wherein the checkout system comprises:
a discount processor operable to:
(i) receive at least a portion of the user-specific discount coupon data transmitted from the card reader; and
(ii) supply purchase discount data, in response to receiving the user-specific discount coupon data, to thereby generate the redeemed user-specific discount coupon data.

56. The system of claim 55, wherein the discount processor is further operable to transmit redeemed user-specific discount coupon data.

57. The system of claim 56, wherein the first card reader is further operable to receive the redeemed user-specific redeemed discount coupon data transmitted by the discount processor.

58. The system of claim 57, wherein:
the card reader is further operable to transmit the user-specific redeemed discount coupon data; and
the coupon data server computer is further operable to receive the redeemed discount coupon data transmitted from the card reader.

59. The system of claim 54, wherein the checkout system comprises:
a product identification processor operable to read product identification indicia on the products selected for purchase and generate the product identification data therefrom.

60. The system of claim 50, further comprising:
a checkout system operable to:
(i) receive at least a portion of the user-specific discount coupon data transmitted from the card reader; and
(ii) transmit user-specific redeemed discount coupon data, the redeemed user-specific discount coupon data representative of electronic coupons that have been redeemed by a user.

61. The system of claim 60, wherein the checkout system comprises:
a discount processor operable to (i) receive at least a portion of the user-specific discount coupon data from the card reader and (ii), in response thereto, to supply purchase discount data and thereby generate the redeemed user-specific discount coupon data.

62. The system of claim 60, wherein the card reader is further operable to receive the redeemed discount coupon data transmitted by the checkout system.

63. The system of claim 62, wherein the card reader is further operable to transmit the redeemed discount coupon data to the coupon data server computer.

64. The system of claim 50, wherein:
the card reader is coupled to a communications network; and
the user identification data is transmitted at least over the communications network.

65. The system of claim 50, wherein the card reader transmits the user identification data via radio frequency transmission.

66. The system of claim 22, wherein:
the coupon data server computer is coupled to a communications network; and
the discount coupon data is transmitted at least over the communications network.

67. The system of claim 50, further comprising:
one or more web pages each having one or more electronic coupons formatted for display on, and selection from, a browser display screen of a client computer.

68. The system of claim 67, wherein the user-specific discount coupon data is stored on the coupon data server computer in response to a user selecting one or more of the electronic coupons displayed in the browser display screen.

69. The system of claim 67, wherein the one or more web pages are stored on the coupon data server computer.

70. The system of claim 67, wherein the one or more web pages are stored on one or more separate server computers.

71. The system of claim 50, wherein the intermediate client-server computer is a stand-alone kiosk.

72. The system of claim 50, wherein the user identification data is stored on one or more magnetic strips coupled to the card.

73. The system of claim 50, wherein the user identification data is stored on the card as bar codes.

74. The system of claim 50, wherein the card is a smart card having a memory for storing at least the user identification data therein.

75. A method of redeeming coupons electronically, comprising:
storing user identification data on a card;
storing discount coupon data that has not been selected by a user of the card on a coupon data server computer;
reading the user identification data from the card and transmitting the user identification data; and
transmitting at least a portion of the stored discount coupon data from the coupon data server computer in response to the reading of the user identification data.

76. The method of claim 75, further comprising:
identifying products selected for purchase,
wherein the discount coupon data that are transmitted are based at least in part on the products identified.

77. The method of claim 75, wherein the discount coupon data that are transmitted are that which are associated with the products identified.

78. The method of claim 75, further comprising:
applying discounts to one or more products selected for purchase based at least in part on the transmitted discount coupon data; and
generating redeemed discount coupon data representative of the discounts the were applied to the one or more selected products.

79. The method of claim 78, further comprising:
transmitting the redeemed discount coupon data to one or more clearinghouse client computers.

80. A method of redeeming coupons electronically, comprising:
storing user identification data on a card;
storing user-specific discount coupon data on a coupon data server computer, the user-specific discount coupon data associated with the user identification data;
transmitting the user-specific discount coupon data from the coupon data server computer to an intermediate computer in response to a request;
reading the stored user-specific identification data from the card; and
transmitting the user-specific discount coupon data from the intermediate computer in response to the reading of the stored user-specific identification data.

81. The method of claim 80, further comprising:
identifying products selected for purchase,
wherein the user-specific discount coupon data that are transmitted from the intermediate computer are based at least in part on the products identified.

82. The method of claim 83, wherein the discount coupon data that are transmitted from the intermediate computer are that which are associated with the products identified.

84. The method of claim 80, further comprising:
applying discounts to one or more products selected for purchase based at least in part on the user-specific discount coupon data transmitted from the intermediate computer; and
generating redeemed discount coupon data representative of the discounts the were applied to the one or more selected products.

85. The method of claim 84, further comprising:
transmitting the redeemed discount coupon data to one or more clearinghouse client computers.

86. The method of claim 80, further comprising:
transmitting a webpage having one or more electronic coupons displayable in, and selectable from, a client computer browser display screen.

87. The method of claim 86, further comprising:
storing the user-specific discount coupon data in response to a client computer user selecting the one or more electronic coupons displayed on the webpage.

88. The method of claim 80, wherein the request to transmit the user-specific discount coupon data from the coupon data server computer comprises:
reading the stored user-specific identification data from the card using a card reader associated with the intermediate computer.
